(19) United States
(12) Patent Application Publication
(10) Pub. No.: US 2008/0040322 A1
(43) Pub. Date: Feb. 14, 2008

(54) Web presence using cards

(76) Inventors: Hal Rucker, Foster City, CA (US); James A. Ruggiero, San Francisco, CA (US); Mark D. Jenkins, San Francisco, CA (US); Joanie L. McCollom, San Francisco, CA (US)

Correspondence Address: MORRISON & FOERSTER LLP, 755 PAGE MILL RD, PALO ALTO, CA, 94304-1018, US

(21) Appl. No.: 11/499,392

(22) Filed: Aug. 3, 2006

(51) Int. Cl. G06F 17/30; G06F 7/00

(52) U.S. Cl. 707/3

(57) ABSTRACT

An Internet web-based system which provides a discrete visual container of multimedia information with interactive functionality using what are termed here cards which are objects displayed on the user's computer screen providing information. The cards can be saved, edited, searched, manipulated, linked and embedded. Unlike conventional web pages, the cards are not created using HTML or any other programming language, but are instead created using an editor thus not requiring programming expertise by the creator. Moreover a group of cards may be provided as a set so that all the information on the stack of cards is available without downloading or hyperlinking. Also provided is a card stack which is a set of cards all displayed simultaneously on one user computer display screen typically in an overlapping fashion where the cards in the set have some relationship to one another. The card stack, like a single card, may be saved, edited, searched, manipulated, linked or embedded.

### FIELD OF THE INVENTION

This invention relates to communication networks, including the Internet and World Wide Web and more specifically to a method of sharing information using the Internet and World Wide Web, the information including multimedia material.

### BACKGROUND

Web-based communities and on-line bulletin boards are popular among Internet users. Some existing communities allow registered users to create their own online presence such as web profiles. Other users can link to these profiles and sometimes add comments. The typical systems, however, often have inflexible user interfaces and offer limited capabilities and generally require programming skills in HTML or related languages such as AJAX, DHTML, Adobe FLEX, and OpenLaszlo. It would be useful, therefore, to have a web-based environment that is more user-friendly and allows users to share information more easily. It would also be desirable to have a system that offers greater flexibility and enhanced functionality.

### SUMMARY

In accordance with the invention, a graphical user interface employing a card or card object is provided to the user via his computer screen, the card being a visual container of multimedia information and interactive functionality. Cards can be saved, edited, searched, manipulated, linked and embedded. Cards provide much of the same functionality to a user as conventional web pages. However unlike web pages, cards are in some embodiments more intimately connected to one and other. For instance, typically web pages are linked by hyperlinks where by clicking on a hyperlink text in a first web page a user can then download a second web page from the website server. In contrast, with the present cards there is no hyperlinking required, and all cards in a set or group are downloaded from e.g. the host or server together. Hence the user can proceed viewing card to card much more quickly than with web pages, and interact with more than one web presence at a time.

Additionally, cards are, unlike web pages, not necessarily coded in the HTML language which is relatively difficult to learn. A card typically is created and published using a template-based “what you see is what you get” editor. The editor is easy to use and it involves typing into a template text. Formatting menus are provided. It is also possible to add images, graphics and videos. None of this requires knowledge of HTML or any other programming language, but it can be done by the naive user who thus becomes his own card creator and editor. The editor supports keyword and navigational searches of the cards. The same editor is used to edit the card later. Hence the user can edit his own cards as he wants after creation. Cards can be set to have a particular life span and automatically removed or hidden from the card set using a time-based system. Thereby when a card is created, a start and end time may be entered by the user during which the card is active or not. This is particularly advantageous, for instance, for a card which relates to an event such as a concert or play. A card may contain multiple configurations depending on how it is being used. Typically these are determined by the size of the card on the user's display screen and the amount of content included. A typical set of configurations would be a small size thumbnail, a medium size partially opened cover state, and a completely opened or full size state.

One aspect of a card is that it can be file inserted into a conventional web-type HTML web page and it serves as an embedded web presence that is linked back to a server which holds the cards. For instance a business organization might have a card that includes text, images and video about its business. A visual representation of a card may be placed on another site's conventional web-type HTML page and serves as a dynamic link back to the server where the full card may be viewed.

Similarly, a card can be embedded in an HTML page so that the entire content and functionality of the card can operate within that web page. A card may contain active functionality including for instance text display, image display, manipulation, video display, messaging, physical address location mapping of a business, and linking. A card may provide functionality that includes communicating and interacting with the entity that posted the card. For instance this might include providing coupons for a business, reporting usage of the card, searching inventory of the business owning the card, email to the card owner and telephone information and a newsletter.

Typically each card, although it is not a web page, can be accessed externally via a conventional web browser since each card has its own unique URL (uniform resource locator).

Additionally a card can be visually embedded into another card thereby establishing in some embodiments a two-way relationship between the cards that is a type of link (not a hyperlink) such as for a business. In other embodiments the link is a one way relationship and includes, but is not limited to for instance, a product endorsement or business endorsement, a recommendation of a business, a business referral, related topic, a business promotion, identification of the card creator, and information relating other cards embedded in a particular card.

Another entity provided here is referred to as a card stack which is a group or set of cards which can be viewed by the user in a single graphical representation on his computer screen. In a card stack all of the cards in the stack are viewed on a single. user display screen, for instance in an overlapping fashion like a partly fanned out deck of playing cards. The cards in the stack have a pre-existing relationship typically established by the card creator. Features of a stack include for instance the ability to view any number of open cards at one time, and the ability to create one's own stack by saving a set of cards as one's own card stack. A card stack has the functionality of a single card including the ability of being saved, edited, searched, manipulated, linked and embedded. In a card stack, the user can navigate between cards without leaving the card stack.

Therefore multiple cards can be displayed and manipulated simultaneously in the fully functional state on a single web page or user computer display screen. One example of this feature is viewing a listing of cards and search results. The content of each card in the search results can be viewed and the full functionality can be executed without leaving the search results list. Thus there is no hyperlinking between the search results and the cards, instead there is a direct connection allowing much quicker access. Thus advantageously the user does not lose his search results when he explores one item in the search. He can keep the search open and navigable on the same screen, hence there is no loss of context. That is, the user can explore a card in the search results list while still viewing other items of the search results and can even open the other items (cards) for simultaneous comparison and exploration of those cards.

Additionally, a card is a type of software object that in some embodiments can be manipulated by physically moving the visual card entities on the screen by the user for instance using his cursor or mouse controls of his computer. For instance, a card can be embedded into another card by dragging its respective thumbnail depiction onto another card on the computer screen. Also provided are a basic user registration and authentication system, and a reporting and management interface for card providers such as businesses to view the performance of their advertising and other card listings. There are also provided conventional interfaces for a local site manager (e.g. by geographical locality) and an overall administrative interface. There may also be provided a shadow site using HTML that can be “crawled” by conventional search engines, which otherwise would not access the cards.

Typically the cards are coded using a well-known program called Flash (provided by Adobe) using Adobe ActionScript which is a commercially available software program. ActionScript has an accompanying Flash player which is commercially available and is typically already a part of most web browsers as a browser plug-in. Alternatives to Flash are e.g. Flex or OpenLaszlo. All of these are commercially available products.

At the host server which supports the cards there is provided a conventional RDBMS such as SQL or similar database of the cards' content with linkages between the cards and the card content. ActionScript is used to write the code provided at the client side which is the user's computer. At the host server side typically the accompanying software is written in the Java programming language or alternatively in Java based “middleware” such as Servlet or Spring or Hibernate.

Therefore provided here is a content or multimedia content container user interface which allows one to access interrelated data without leaving a content search context and without hyperlinks. This allows one to explore the content without the need for conventional hyperlinking or downloading. Therefore provided is a navigable collection of data, without linking, on one card. Typical applications are providing an interactive database, an online community, a website that serves local communities, a web presence for business or organization or individual that does not require a website or web page per se, online advertising, social networking, e-commerce, citizen journalism, product and service reviews, broadcasting and blogging. Moreover, the system need not be implemented on the internet or world wide web; it may be supported by other types of data and communication networks also.

### BRIEF DESCRIPTION OF THE DRAWINGS

Various embodiments of the invention are disclosed in the following detailed description and the accompanying drawings.

FIG. 1 is a diagram illustrating a system embodiment according to the present invention.

FIGS. 2A-2C are diagrams illustrating several embodiments of a card interface.

FIG. 3 is a flowchart illustrating an embodiment of a process for creating a card object.

FIGS. 4A-4E are diagrams illustrating sample graphic user interfaces used in a card object creation wizard.

FIG. 5 is a flowchart illustrating an embodiment of a process of using a stored card object.

FIGS. 6A, 6B are diagrams illustrating an embodiment of a user interface that allows card object embedding, specifically saving a card using drag and drop in FIG. 6A and linking cards using drag and drop in FIG. 6B.

FIG. 7 is a flowchart illustrating an embodiment of a process for updating a card object.

FIG. 8 is a diagram illustrating an embodiment of an interface for displaying multiple cards.

FIGS. 9A-9D are diagrams illustrating an example of a card stack.

FIG. 10 is a diagram illustrating architecture of components of the present system.

### DETAILED DESCRIPTION

The invention can be implemented in numerous ways, including as a process, an apparatus, a system, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An Internet based information sharing system is described using conventionally a host (server) computer with associated software and a user (client) computer with associated software. In some embodiments, information for various entities and topics is stored as objects which are displayed as cards and displayed to users as cards. The user interface with which the cards are presented allows the card objects to be automatically embedded into one another. A card stack is used in some embodiments to organize multiple cards in the user interface.

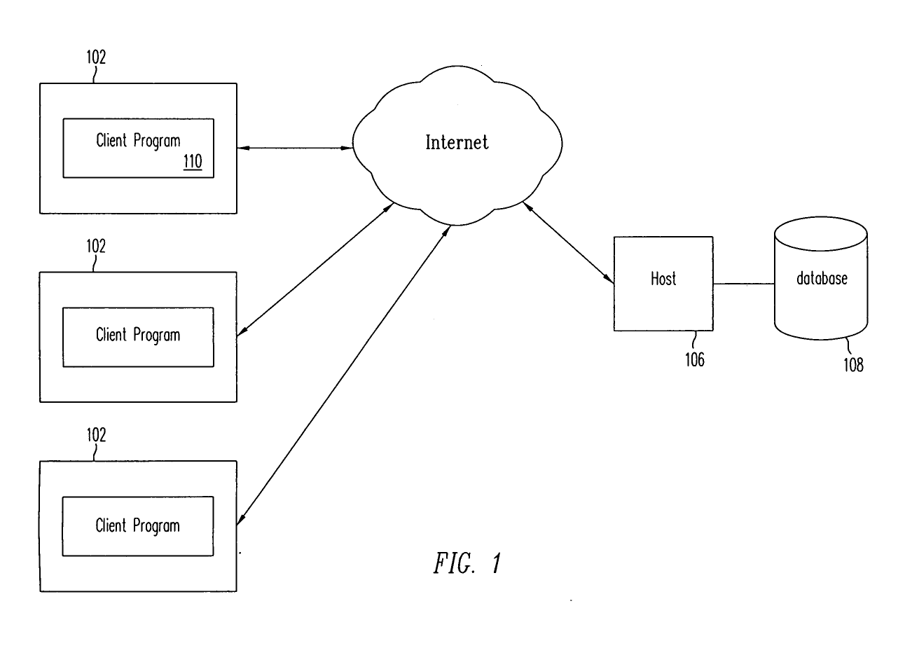

FIG. 1 is a diagram illustrating a system embodiment according to the present invention. In this example, clients 102 are connected to a host 106 via the Internet. The host includes one or more devices that provide server functions such as data processing. In the example shown, the host also includes a database 108. The clients can be a variety of computers or electronic devices that have the capabilities to process data, provide user interface, and connect to the web host via a network. A typical client includes an interactive graphical user interface program 110 configured to allow users to interact with host 106. The interactive graphical user interface may be implemented to execute in browser programs, browser plug-ins, as well as any other software platform capable of sending and receiving information between the user and the server, and processing and displaying the information received.

In the example shown, when a user initially accesses a website provided by the host, at least a part of the interactive graphical user interface or some of the data used by the interactive graphical user interface is downloaded from the host to the client. For example, in some embodiments, at least a portion of the code for executing the interface program is normally stored on the host. When a user accesses a website on the host, the relevant code (software) is downloaded to the client to be executed in a browser.

In some embodiments, the interactive graphical user interface employs vector-based rendering technology to provide a rich user experience that does not require frequent page refreshes. For example, in some embodiments, the interactive graphical user interface is implemented at least in part using ActionScript™. The relevant code is downloaded to the client and played by a Flash™ plug-in operating in conjunction with the conventional web browser at the client. Flash refers to both the Adobe Flash Player (client side application) and to an associated multimedia authoring program used to create content. The Flash Player is a widely used browser plug-in, and supports a scripting language called ActionScript. The actual information in the cards is resident in a conventional SQL database resident at the host server.

Users can create, modify, and manipulate information using the program, sometimes in conjunction with one or more server programs operating on the host. Specifically, within a website identified by its universal resource locator (URL), users can easily construct a type of web presence using card objects. As used herein, card objects generally refers to (not limiting) virtual (computer software) objects that contain information such as information about a business establishment, community discussions surrounding a topic, feedbacks, referrals, events, user profiles, etc. In some embodiments, the card objects are saved in the database associated with the host, and displayed to the user via the program on the client in the form of cards displayed in a browser window. In some embodiments, the cards being displayed are updated dynamically to present the most recent information associated with the objects. As will be shown in more detail below, in some embodiments, multiple card objects are organized and presented using a card stack.

Further, the card objects can be shared, searched, annotated, flagged, reported, forwarded, linked, embedded, cross referenced, or otherwise manipulated. They are sometimes configured to provide additional functions such as offering coupons, requesting quotes, tracking inventory, displaying photos, scheduling events, etc.

In some embodiments, card objects include local information specific to a particular geographic area, and are useful for serving the needs of users in the area. For example, a restaurant owner may wish to provide certain information about his establishment to his local customer. A card object for the restaurant is created, and can be easily updated to reflect changes to the menu, offer promotions, etc. A regular customer of the restaurant may wish to give a restaurant review or recommend the restaurant to others. He can create a card object to specifically recommend the restaurant, or embed a reference of the restaurant card object in online conversations with others.

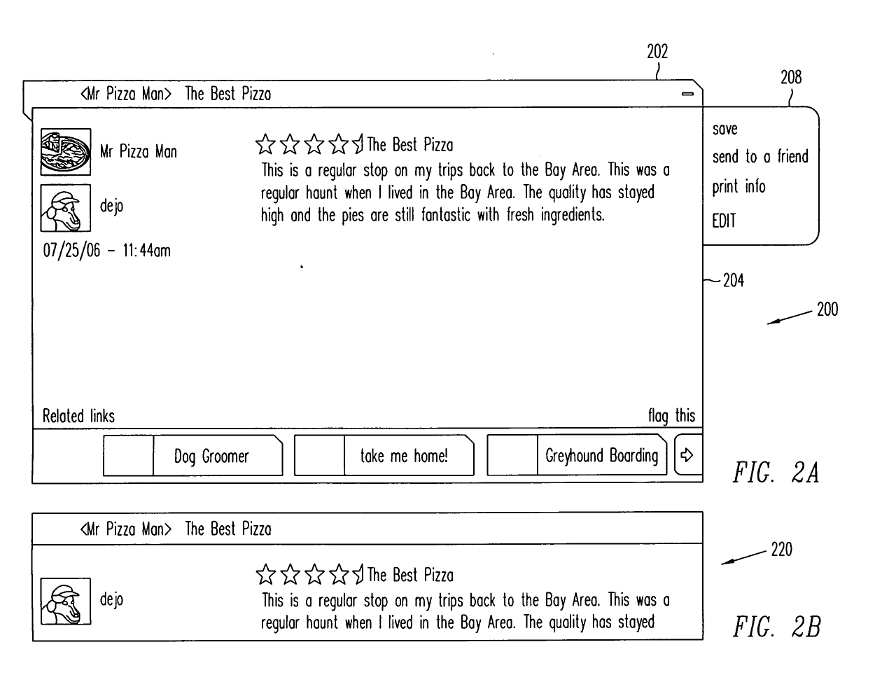

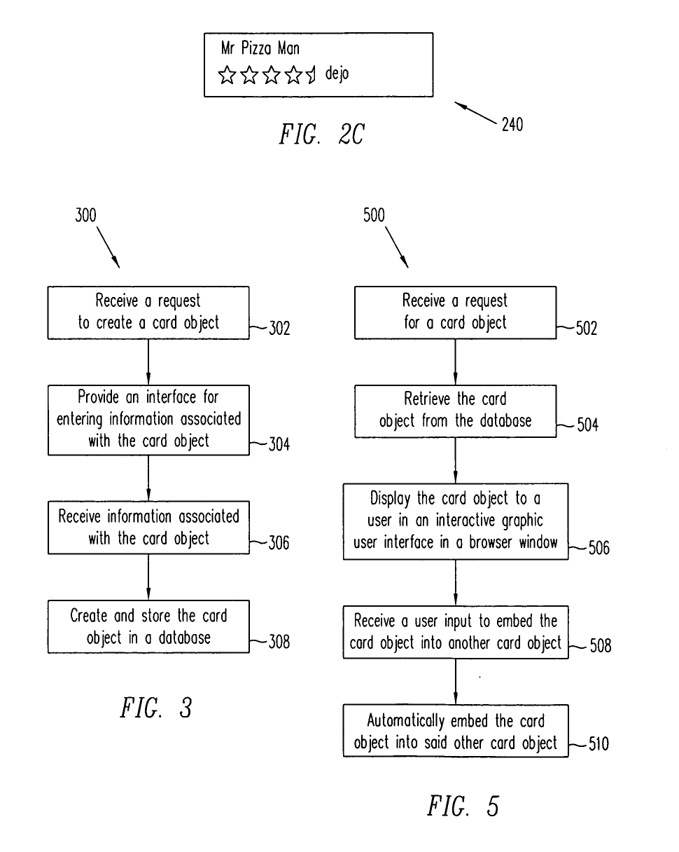

FIGS. 2A-2C are diagrams illustrating several embodiments of a card interface in terms of what is displayed on the user's computer display (screenshots). In this example, the card object is displayed to the user as a card. The same card object can be displayed in several different forms. In FIG. 2A, a fully expanded card 200 is displayed. An intermediate card 220 that is smaller than the fully expanded form and displays less information is shown in FIG. 2B. The intermediate card can be used, for example, to present search results so that information about several card objects can be displayed within a single screen. A small thumbnail form 240 that only displays title or identification information for the card object is shown in FIG. 2C. The thumbnail form can be used, for example, to store card objects saved by a user, or indicate that a card object is embedded in the content of another. Each of the card objects is assigned a unique Universal Resource Locator (URL) that can be used, among other things, for identifying and locating specific card objects. Other types of unique identifier such as serial numbers are also used in some embodiments.

The example shown in FIG. 2A is a fully expanded card. Card 200 includes a header area 202 that includes text that describes and/or identifies the card object, and a content area 204 that includes information about the card object. Other layouts are possible. In some cards, a portion of the information associated the card objects is displayed at one time, and the rest of the information is accessible at the user's request. In the example shown, the card object includes several reviews of a restaurant. One review is displayed in the card's content area at one time. A user may access other reviews by using a conventional navigation bar (not shown). A tools area 208 includes several tabs that are labeled with actions a user is permitted to take with this card object. For example, by clicking on “add a comment”, the user can create comments to the topic associated with the card object. By selecting “send to a friend”, the URI, associated with the card object is emailed to an address chosen by the user. Different types of card objects may implement different tools.

FIG. 3 is a flowchart illustrating an embodiment of a process for creating a card object. This process may be implemented on the host, the client, or a combination of both. In the example shown, process 300 begins when a request to create a card object is received (302). Such a request can be made by a user who has logged on to the website. Various interface tools are used to provide the user with facilities to create different types of card objects. For example, the user may select a “create a new profile” button to create a profile card object, or select a “write a review” button to create a review card object. The request optionally includes information about the context in which the user made the request is also received. For example, when a user has opened a card object for a business, and selects the “write a review” button, information about the business card object, such as a reference to its URL is included in the request.

An interface (editor) for entering information associated with the card object is provided (304). In some embodiments, the interface is implemented as a “what you see is what you get” (WYSIWYG) editor, which means that the interface provides intuitive, visual editing functions including suitable templates such that the user can create and later edit card object information without having to manually modify the code used to render the objects or indeed do any programming. In some embodiments, the interface includes a “wizard” that guides the user through the creation process. Once information associated with the card object is received (306), the object is created and stored in a database (308).

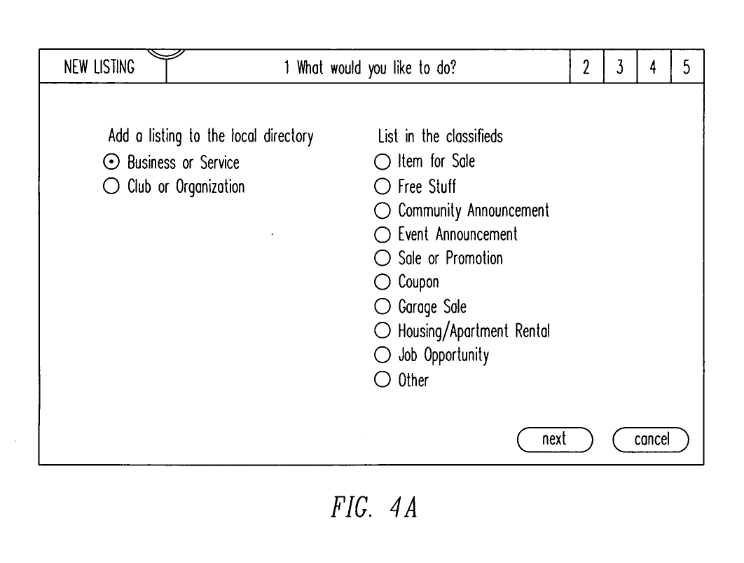

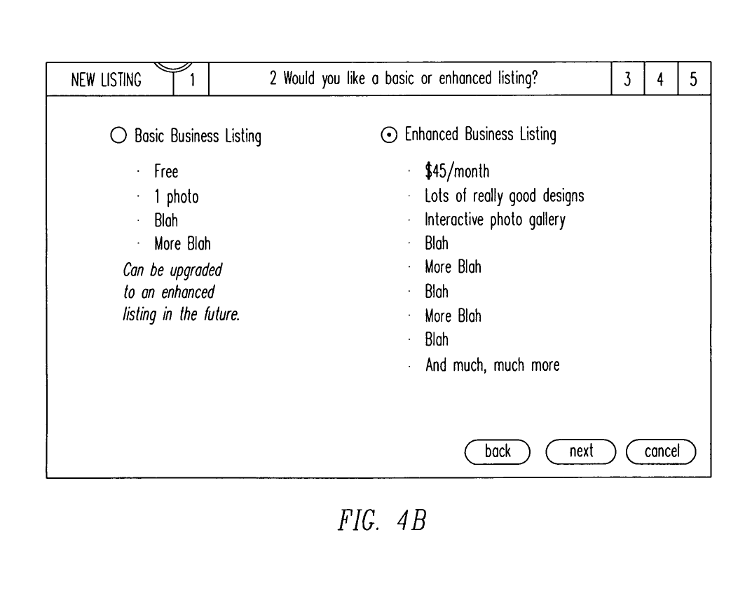

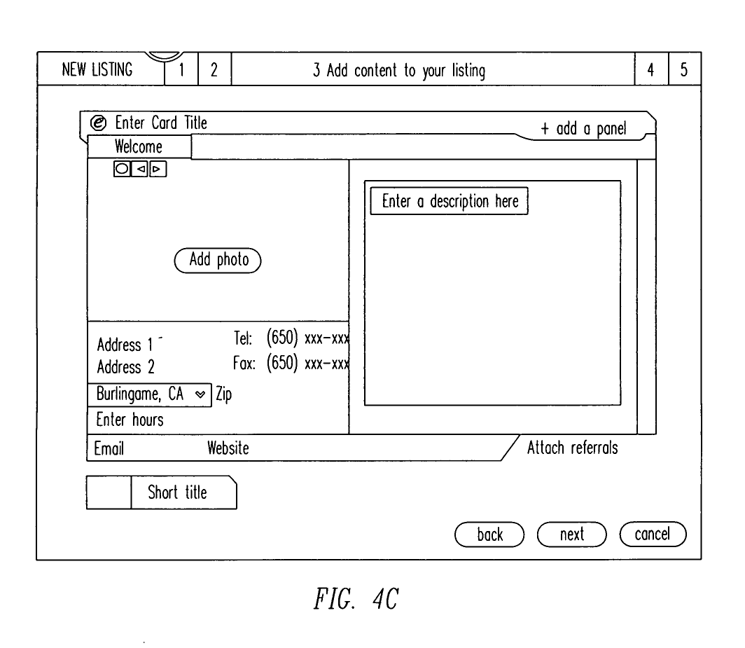

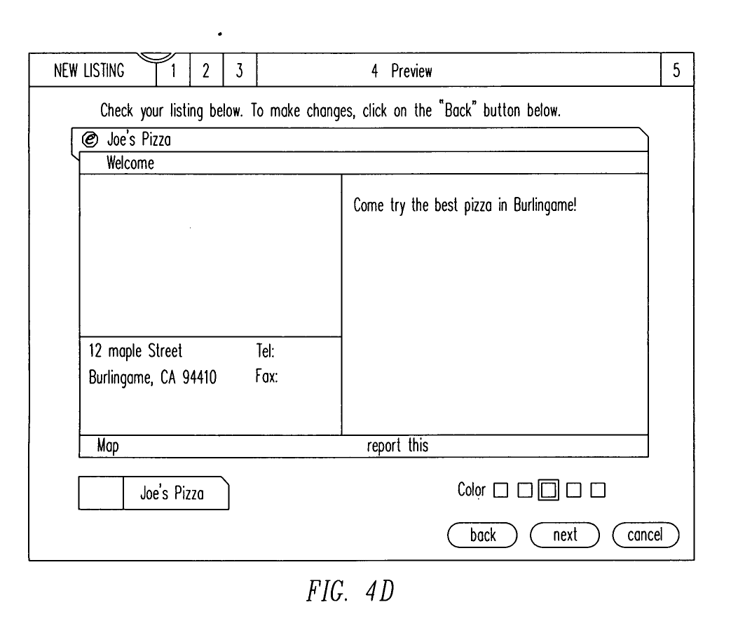

FIGS. 4A-4E are diagrams illustrating exemplary graphic user interfaces used in a card object creation editor. In the example shown in FIG. 4A, the user is prompted to select the type of card object being created (e.g. whether it is a business or service, or a community group such as a club or organization). He is further prompted to select a category under which the card object is listed, such as for sale, announcement, coupon, etc. In FIG. 4B the user selects a basic or enhanced listing; typically the system operator charges for the enhanced listing. In FIG. 4C, a card object template is shown to the user. The user can directly edit fields such as description, contact information, title of the card, etc. Additional information such as photos, audio and video files may be uploaded as well and added to the card in FIG. 4C. In FIG. 4D, the user can further edit the card. In FIG. 4E, keywords are added for purposes of searching. Other configuration choices are possible. For example, the card object is sometimes configured to provide interactive functions such as offering coupons, requesting quotes, tracking inventory, displaying availability of items, etc. Different sets of interface options may be available for creating a review or a personal profile for a user.

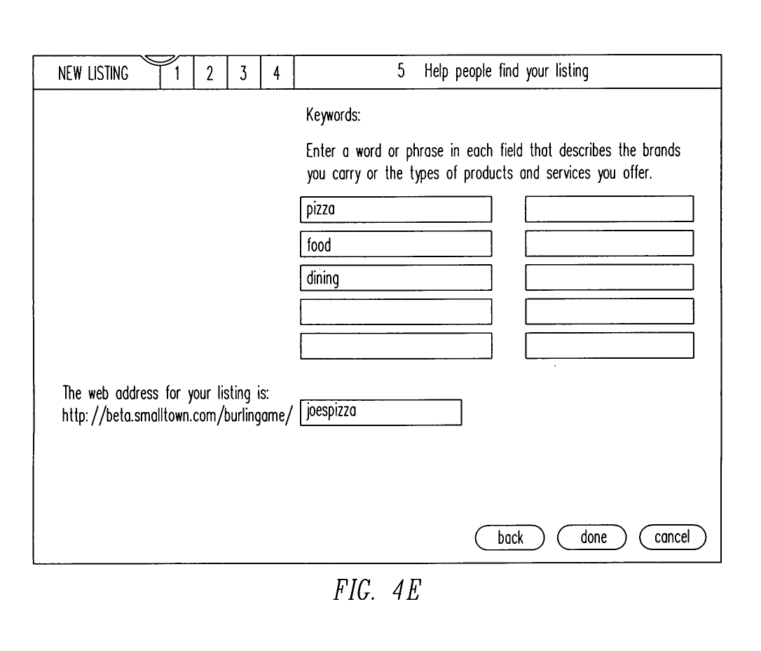

A card object stored in the database is retrieved and used in response to user requests. FIG. 5 is a flowchart illustrating an embodiment of a process of using a stored card object. In this example, process 500 begins when a request for a card object is received (502). There are a number of ways to make such a request. For example, the user may enter a search term, or select a card object that is embedded in another card object. The appropriate card object requested is retrieved from the database (504). For example, if the request came from a search using a specific search term, a database query based on the search term is made and the results are returned. Alternatively, for a request initiated by selecting an embedded card object, the card object is retrieved based on its corresponding URL or identifier.

The card object is displayed to the user in an interactive graphic user interface within a browser window (506). Similar to the graphic user interface used in creating the card object, the user interface for displaying the requested card object is a WYSIWYG interface that allows the user to interact with the cards by actions such as drag-and-drop and menu selection again without the need for software programming.

At some point, a user request to embed the card object in a different card object is received (508). For purposes of clarity here, the card object being embedded is referred to as the first card object and the card object in which the first card object is embedded is referred to as the second card object. The request indicates that the user has requested that a reference of the first card object be included in the second card object. Thus, when the second card object is displayed, a reference such as a thumbnail version of the first card object is embedded and shown, and a viewer of the second card object can access the first card object by selecting the reference. The request to embed can be made in several ways. An explicit request is made, for example, when the user drags the card and drops it into another open card that is displayed in the same browser window. Sometimes the request is an implicit one. For example, while a user is viewing a card representing a restaurant, he can choose to generate a review for the restaurant. A restaurant review card object is thereby created. Because of the context in which the review card object is created, there is an implicit request to embed the restaurant's card object into the review card object, and vice versa.

In response to the user request for embedding, the first card object is automatically embedded into the second card object (510). In other words, links or references between the card objects are automatically created in response to the user request, appropriate fields of the objects are updated, and no manual encoding is required. In some embodiments, certain tests are performed to determine whether a card object is allowed to be embedded into another. The tests are configurable and may vary depending on the system. For example, in some embodiments, the card types are examined, and a card object representing one business is not allowed to be embedded into a card object representing another business.

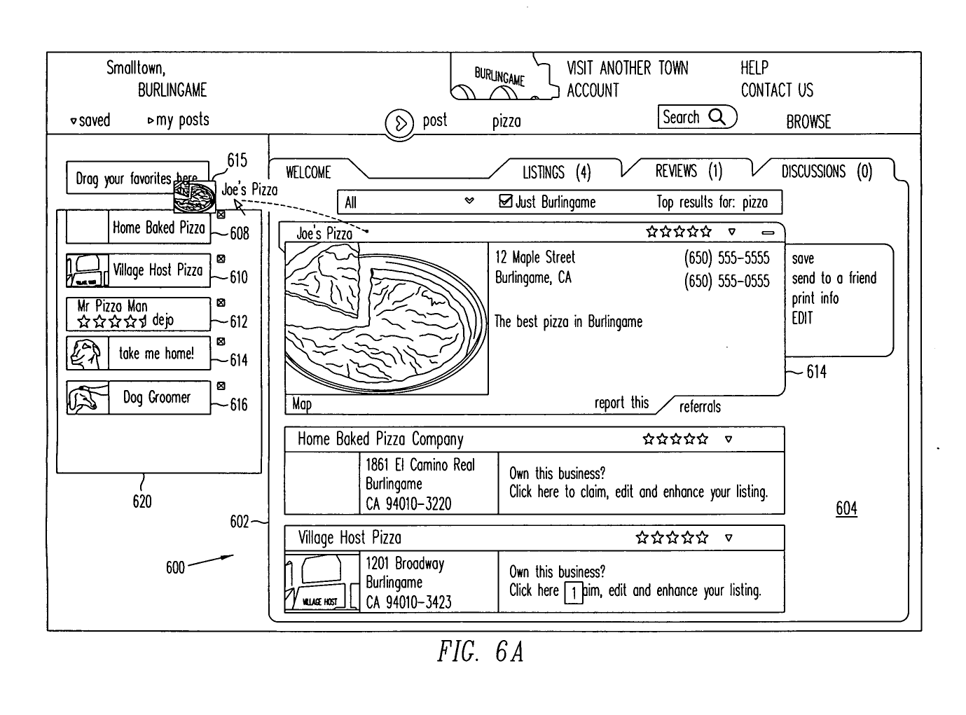

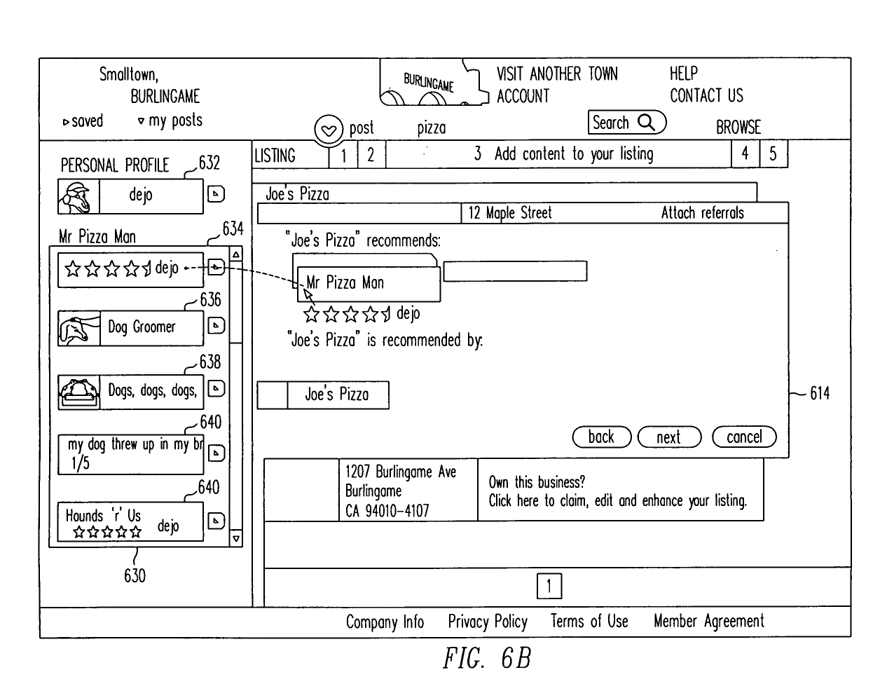

FIG. 6A is a diagram illustrating an embodiment of a user interface that allows card object embedding. In this example, a browser window 600 is open and shown to include several areas. Area 602 displays search results in response to a search for pizza. In this example, the search is location dependent. By default, only pizza restaurants located in the same geographical area as the user are displayed in the search results, although the user is allowed to select other geographical areas for the search. As shown, the search results displayed are card objects of several local restaurants that serve pizza. The corresponding cards are shown in their intermediate form.

Area 604 is for saving cards (“favorites”) and accessing saved cards. A number of card objects such as 608-616 are already embedded in area (card) 620. Here, the embedded card objects are displayed in their thumbnail form to conserve space. Other displays are possible. In the example shown, the user can select a card displayed in the search results, for instance card object 614 (Joe's Pizza), by moving the cursor over the object and clicking on the object. The selected card 614 is changed to its thumbnail configuration 615 and dragged from the search results area and dropped into card 620. This action creates a linkage between the user's “favorites” card object and the selected card object. A card 615 corresponding to Joe's Pizza will be displayed within the card 620. If the card object 614 representing Joe's Pizza is modified, the updated information will be reflected in the “favorites” card object 620, and the display is updated accordingly. For example, if photo used in Joe's Pizza card object is changed, the new photo will be displayed in card object 620. Details of the update are further discussed below.

In this example, area 620 is used for storing card objects the user may wish to reference at a later time. It includes a collection of saved card objects, which are displayed in their thumbnail form. In this example, the collection is created while the user is using the system to search, browse, or otherwise view various cards. If the user wishes to save a particular card, he can drag it from the place where the card is displayed and drop it into the saved area, or click on a “save” button in the tools area of the card to be saved. Further, the user can drag a card saved in area 620 and drop it into another card to create linkages or references between the card objects. FIG. 6B is similar to FIG. 6A, but shows in the left side of the figure rather than the “favorites” or saved area 620 instead the “my posts” area (card object) 630. The “my posts” area 630 includes several cards 632-640, but each of these is a card created by the user (hence called “my posts”.) The user can toggle between “favorites” in FIG. 6A and “my posts” in FIG. 6B. The user can take a “my posts” card and drag and drop it into another open card on the screen, such as the Joe's Pizza card 614 as shown in FIG. 6B by the broken line. This allows the user by clicking and dragging the thumbnail from “my posts” to an open card to link cards. Hence the saved (“favorites”) area 620 holds any card the user wants to save, while the “my posts” card area holds only cards the particular user created such as reviews, business listings, etc.

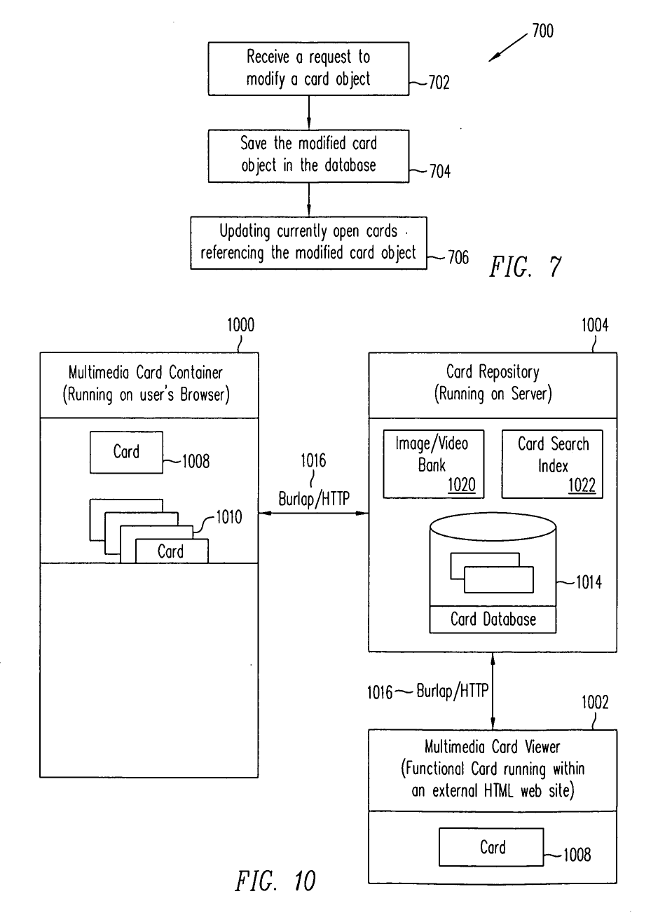

FIG. 7 is a flowchart illustrating an embodiment of a process for updating a card object. Process 700 may be implemented on the host device, the client device, or a combination. In this example, process 700 begins when a request to modify a card object is received (702). The modification request is sent, for example, when a user changes information displayed in a card and selects the save function. Optional checking takes place in some embodiments to determine whether the changes meet certain requirements such as formatting requirements, and the process is only allowed to proceed if the requirements are met. The modified card object is stored in the database (704). New information contained in the card object will be displayed when its card, or any other card in which it is embedded, is opened later.

Further, currently open cards referencing the modified card object are updated as appropriate (706). The currently open cards include cards that correspond to card objects in which the modified card object is embedded, as well as any open cards displaying information in the card prior to its modification. The update may be accomplished using a number of techniques. For example, in some embodiments, when the modification is saved in the database, the host automatically signals clients currently accessing the website that a change has taken place. In some embodiments, the signal includes information about the modified card object so the clients can check the cards that are open and determine whether updates should be made. In some embodiments, the clients poll the host either periodically or when a signal is received to refresh the cards currently displayed using the most current information in the database. In some embodiments, the clients refresh cards when a new search is performed, when the user logs in, or when the user specifically requests that his copy of the card be updated.

Since each card object may embed one or more card objects, a user may open a series of cards by following the embedded references. The nested nature of cards may be demonstrated by the following example: first, the user opens a card 802 (see FIG. 8) entitled Joe's Pizza. Several other card objects are embedded in the Joe's Pizza card 802, one of which is Joe's Profile 804. The user selects Joe's Profile and opens the card 804. Joe's profile 804 embeds references to other cards, in this case the card 808 for the Pez Museum.

In some embodiments, the card objects are opened and displayed individually, in multiple windows or as separate card objects in the same window. It is possible for the card objects (or windows containing individual card object) to overlap each other. Some card objects may be blocked, making it somewhat difficult for the user to locate a specific card object and navigate among them, especially when there are a great number of cards. Thereby FIG. 8 illustrates an embodiment of an interface for displaying multiple cards. In this example, several cards are open, and Joe's Profile 804 is shown in the foreground. The lower portions of cards 802 and 808 are blocked by Joe's Profile card 804. To see all of card objects 802 and 806, the user has to bring the cards to the foreground or close other cards overlaid on top to view them

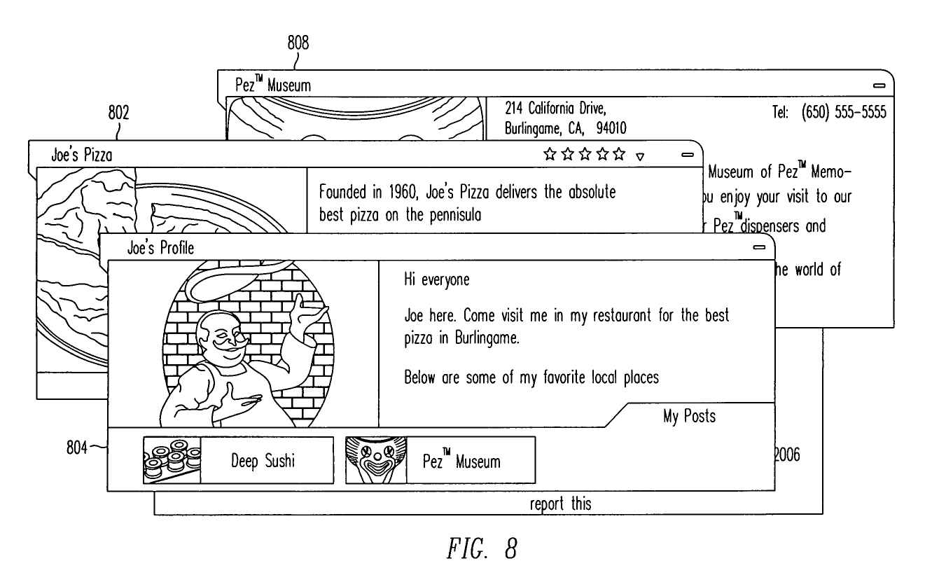

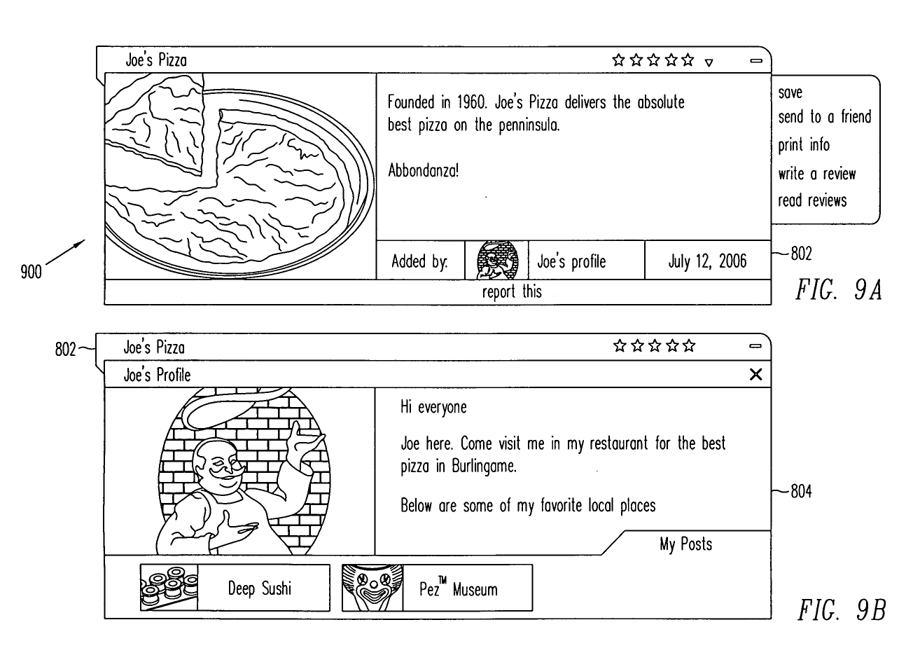

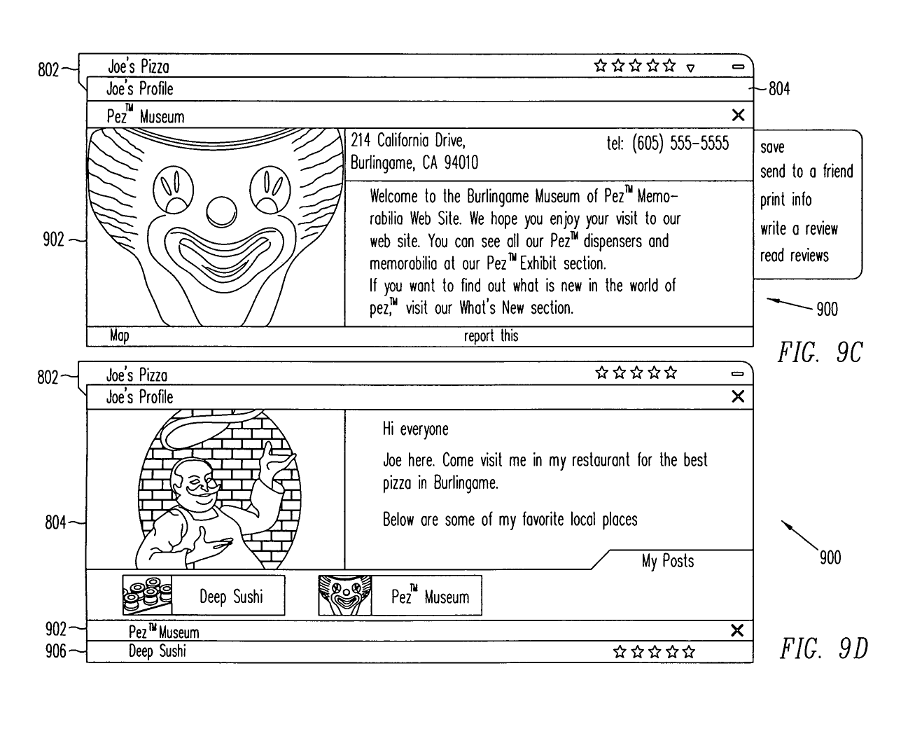

In some embodiments, to improve the user experience when multiple cards are opened, a card stack is used for organization and display. In a card stack, multiple cards are displayed, and the headers of all the cards in the card stack are displayed at all times. FIGS. 9A-9D are diagrams illustrating an example of a card stack. In the example shown in FIG. 9A, card stack 900 is created when the user first opens a card, in this case Joe's Pizza card 802. In FIG. 9B, when Joe's Profile 804, which is embedded in Joe's Pizza 802, is opened, Joe's Profile 804 is placed on top of the stack 900. The most recently opened card 804 is displayed in the foreground, on top of the previously opened card 802. The stack 900 is arranged in such a way that the header of the previous card is still visible. As other cards such as the Pez Museum 902 in FIG. 9C and the card for Deep Sushi 906 in FIG. 9D are opened, they are ordered and placed in the same fashion, forming card stack 900. FIG. 9D thereby shows card stack 900 with four opened cards.

In the example shown in FIG. 9D, a card in the middle of the stack, entitled Joe's Profile, is selected. In this example, the user selects the card by clicking on the header portion 908 of the card. The selected card 804 expands to display its full content. The expanded card does not block the header of any other cards in the stack 900. Rather, the card stack rearranges its display so that the headers of all the cards remain visible. In the example shown, the cards are displayed in the same order as they are opened. The card opened before Joe's Profile, in this case Joe's Pizza 802, and the cards opened after Joe's Profile, Deep Sushi 906 and Pez Museum 902, are all minimized to show only the header portion. The user may open any card in the stack by clicking on its header, and the rest of the cards are automatically minimized to show only the header portions. Further, the user may close any card by clicking on a “close” button (upper right of each card header), or right-clicking anywhere on the header area and selecting the close option.

Although the example above shows a card stack having cards that are embedded in one another, the card stack can also be used to manage cards that are not necessarily related. For example, in some embodiments, a card stack is created every time the user logs onto the website, and all the cards opened by the user are added to the stack. In some embodiments, the user can define and create card stacks, and add or remove cards to the stack at will.

The card search, display, editing, linking and viewing is implemented via three software (computer program) components shown in FIG. 10: the Multimedia Card Container 1000, running on the user's internet browser; the Multimedia Card Viewer 1002, running on the user's internet browser inside an external HTML web site; and the Card Repository 1004, running on internet-accessible (host) services. The functionality is implemented within the Multimedia Card Container 1000—this component visually displays the cards 1008, allows them to be moved, opened and closed, allows them to be dragged and dropped into card receptacles, and allows multimedia content to be added to cards. This module also implements the card stack 1010, which is the depicted collection of related cards that can be flipped through by the user. The Multimedia Card Container does not use HTML pages to render cards; they are rendered as composite visual elements animated via ActionScript object-oriented code of the Flash browser plugin. This design choice allows rich animations of the cards and card stacks, integration of multimedia content such as video, and the ability to continue to render and animate active cards without being connected to the internet.

A single functioning card 1008 can be embedded in any web site by using the Multimedia Card Viewer 1002. This application, also running on Adobe Flash/ActionScript, allows a single card to be viewed and explored from anywhere on the internet, including within third-party HTML web sites. Card owners (posters) can use the Multimedia Card Viewer to externally embed their card in other web presences, as well as that provided by the Multimedia Card Container.

The remainder of the functionality is implemented in the server-side Card Repository 1004, which returns individual cards or lists of cards to the Multimedia Card Container or the Viewer. This module 1004 is responsible for executing keyword searches which summon up a collection of cards matching that keyword; for permanently storing the text and multimedia content of all cards in database 1014 so they can be reloaded as needed; for maintaining information about the relationships between cards; and for storing a database 1014 of users who own and edit cards. The initial implementation of the Card Repository is in e.g. the Java programming language, using the following technologies: the Tomcat Servlet Engine, the Spring web coded framework, a MySQL (type of SQL) database engine for database 1014, the Lucene text search engine for searching and the Apache web server (all commercially available).

The network protocol in the version used to communicate between the Card Container and Card Repository is an XML-based protocol called Burlap (commercially available) 1016, invoked using HTTP; Burlap is also used to communicate between Repository 1004 and Viewer 1002.

Visual and interactive behavior is implemented in the Multimedia Card Container 1000. This application, running directly within the user's internet browser, displays and animates cards 1008 that interest the user, and allows guided exploration of these cards via visible lists, pages and stacks 1010 of retrieved cards. If the internet link between the Multimedia Card Container and the Card Repository 1004 is severed, the user can still browse the cards already loaded, navigate card stacks and interact with the individual cards, but cannot summon up additional cards from the database 1014 or make changes to their cards.

The Multimedia Card Viewer 1002 provides a subset of the functionality of the Multimedia Card Container, specifically the ability to render and animate a single card 1008. The smaller visible size of this application allows it to be embedded within external HTML web sites and still display current card data and multimedia content. The Card Repository 1000 is responsible for user login/security and management of the database 1014 of card text, multimedia content and relationships. The Multimedia Card Container makes periodic requests to the Card Repository for lists of cards or for individual cards, then saves them for later display. The Card Repository responds to requests from the Multimedia Card Container by transmitting entire cards or card stacks over the network connection, including all text and multimedia content. The Card Repository manages the card database 1014 (described above), a storage 1020 (bank) of images and video associated with particular cards, and a card search keyword index 1022, also described above.

Although the foregoing embodiments have been described in some detail for purposes of clarity of understanding, the invention is not limited to the details provided. There are many alternative ways of implementing the invention. The disclosed embodiments are illustrative and not restrictive.

1. A computer enabled method of interacting with information in a communications network based system, comprising the acts of:
receiving a request from a user for an object which stores the information;
retrieving the object from a database associated with the communications network based system; and
displaying the object as a card to the user in an interactive graphic user interface.

2. The method of claim 1, further comprising:
receiving a request from a user to embed the object into another such object; and
embedding the object into the another object.

3. A method as recited in claim 2, wherein the user request includes an explicit request to embed the object into another object.

4. A method as recited in claim 2, wherein the user makes the user request explicitly in the graphic user interface.

5. A method as recited in claim 2, wherein the user request includes an implicit request to embed the object into another object.

6. A method as recited in claim 1, further comprising the acts of:
modifying the object;
storing the modified object in the database; and
updating a currently opened object referencing the modified object.

7. A method as recited in claim 1, wherein the object is configured to include physical location information pertaining to a person, business, organization, event, review, recommendation, or comment.

8. A method as recited in claim 1, wherein the object is configured to include physical location information, and the request for the card object is based at least in part on the physical location information.

9. A method as recited in claim 1, wherein the object includes information about a person, business, organization, event, discussion, review or comment.

10. A method as recited in claim 1, further comprising saving a reference to the object in a designated area of the interactive graphical user interface.

11. A method as recited in claim 1, wherein the object is displayed in a stack of such objects.

12. A method as recited in claim 1, wherein:
the object is displayed as one of a stack of objects;
the stack includes a plurality of cards;
each of the plurality of objects has a header; and
the header of each of the plurality of objects remains visibly displayed so long as each of the plurality of objects remains open.

13. A method as recited in claim 1, further comprising the acts of:
providing an editor with templates adapted to creating and modifying the object.

14. A method as recited in claim 1, further comprising the acts of:
providing a plurality of keywords associated with each object; and
searching for a particular object using the keywords or text searching.

15. A method as recited in claim 1, further comprising the acts of:
providing a plurality of configurations for each object of varying size when displayed; and
displaying each configuration depending on use of each object.

16. A method as recited in claim 1, further comprising the acts of:
embedding the object or a file associated with the object in a web page; and
linking to the object via the web page.

17. A method as recited in claim 1, wherein the object includes at least one of:
text, image, video, messaging, physical location mapping, and linking.

18. A method as recited in claim 1, further comprising the acts of:
assigning the object a URL (uniform resource locator).

19. A method as recited in claim 2, wherein the embedding establishes a two-way relationship between the two objects.

20. A method as recited in claim 10, wherein the relationship includes at least one of:
an endorsement, a recommendation, a referral, a related topic, a promotion, an identification of an object creator, and information pertaining to other such objects that are embedded in one of the objects.

21. A method as recited in claim 11, further comprising:
saving a group of such objects which are related.

22. A method as recited in claim 11, wherein the stack is subject to at least one of the functions of being:
saved, edited, searched, manipulated, linked, and embedded.

23. A method as recited in claim 22, wherein a plurality of the objects in the stack are displayed together and each is manipulated.

24. A method as recited in claim 2, further comprising:
embedding the object into another object by moving on a computer display a depiction of the object onto a depiction of another object.

25. A computer program product for interacting with information in a communications network based system, the computer program product being embodied in a computer readable medium and comprising computer instructions for carrying out the method of claim 1.

26. A communications network based system for interacting with information, comprising:
a processor; and
a memory coupled with the processor, wherein the memory is configured to provide the processor with instructions which when executed cause the processor to:
receive a request for an object which includes the information;
retrieve the object from a database associated with the communications network based system; and
display the object as a card to a user in an interactive graphic user interface.

27. A computer enabled method of interacting with information, comprising:
opening a plurality of objects which are displayed as cards, each of the plurality of objects being associated with stored information;
displayed on a computer screen the plurality of cards in a stack of the cards, wherein a header of each of the plurality of cards remains visible so long as the card remains open.

28. A computer enabled method of providing information to a user, comprising the acts of:
displaying an object which includes information in an interactive graphic user interface;
wherein the object is retrieved from a remote database; and
wherein the object is displayed as a card.
